(19) United States
(12) Patent Application Publication
(10) Pub. No.: US 2018/0138741 A1
(43) Pub. Date: May 17, 2018

(54) SYSTEM AND METHOD FOR LOCAL POWER GENERATION

(71) Applicant: JEFFREY ALLAN VELTRI, Burlington (CA)

(72) Inventor: JEFFREY ALLAN VELTRI, Burlington (CA)

(21) Appl. No.: 15/815,176

(22) Filed: Nov. 16, 2017

Related U.S. Application Data
(60) Provisional application No. 62/423,072, filed on Nov. 16, 2016.

(51) Int. Cl. H02J 9/06; H02J 3/14; H02J 3/40

(52) U.S. Cl. CPC H02J 9/066; H02J 2009/068; H02J 3/40; H02J 3/14

(57) ABSTRACT

A system for powering an electric load. The system includes a local generator generating an electric current, a current synchronization subsystem, and a controller. The current synchronization subsystem is coupled to the local generator and to an electric grid, synchronizing the electric current generated by the local generator with a grid current provided by the electric grid to provide a synchronized alternating current to said electric load. The controller is coupled to the local generator and to the electric load and is configured to dynamically set an output power of said local generator to provide the electric load with electric power equal to an instantaneous power drawn by the electric load less a defined baseline power, and cause the electric grid to provide the defined baseline power to the electric load.

### CROSS REFERENCE TO RELATED APPLICATIONS

This application claims the benefit of U.S. Provisional Application No. 62/423,072, filed Nov. 16, 2016, hereby incorporated by reference in its entirety.

### FIELD

Electric power generation system and methods, in particular for powering an electric load using a local power generator.

### BACKGROUND

Backup power generators are often used to power an electric load in the event of a loss of power from the electric grid (i.e. a power outage). Power generators can provide electric power by burning fuels, such as natural gas, propane, and diesel. Power generators can, for example, be installed locally at residences or commercial offices.

Locally installed power generators are typically connected to a transfer switch allowing users to choose between powering the electric load using power from the electric grid and using power from the local generator. The transfer switch typically allows only one of the local generator and the electric grid to be connected to the electric load.

Nonetheless, it may be desirable to operate a grid-connected, locally installed backup power generator. Accordingly, improved systems and methods for local power generation are desirable.

### SUMMARY

In accordance with an aspect of the present disclosure, there is provided a system for powering an electric load, the system comprising a local generator generating an electric current; a current synchronization subsystem coupled to said local generator and to an electric grid, synchronizing the electric current generated by said local generator with a grid current provided by the electric grid to provide a synchronized alternating current to said electric load; and a controller coupled to said local generator and said electric load, said controller operable to dynamically set an output power of said local generator to provide said electric load with electric power equal to an instantaneous power drawn by said electric load less a defined baseline power, and cause said electric grid to provide said defined baseline power to said electric load.

In accordance with another aspect, there is provided a method for powering an electric load, the method comprising generating, by a local generator, an electric current; dynamically setting, by a controller, an output power of said local generator to provide said electric load with electric power equal to an instantaneous power drawn by said electric load less a defined baseline power; causing, by said controller, an electric grid to provide said defined baseline power to said electric load; and synchronizing, by a current synchronization subsystem, the electric current generated by said local generator with a grid current drawn from said electric grid.

In accordance with another aspect, there is provided a non-transitory computer readable storage medium including instructions that when executed by a system for providing electric power to an electric load, the system comprising a local generator generating an electric current, a current synchronization subsystem coupled to said local generator and to an electric grid, synchronizing said electric current generated by said local generator with a grid current provided by the electric grid, and a controller coupled to at least one of said local generator, said electric load, to cause the system to dynamically set an output power of said local generator to provide said electric load with electric power equal to an instantaneous power drawn by said electric load less a defined baseline power, and cause an the electric grid to provide said defined baseline power to said electric load.

Other aspects, features, and embodiments of the present disclosure will become apparent to those of ordinary skill in the art upon review of the following description of specific embodiments in conjunction with the accompanying figures.

### BRIEF DESCRIPTION OF DRAWINGS

In the figures, which illustrate, by way of example only, embodiments of the present disclosure,

FIG. 1 is a block diagram illustrating a system for powering an electric load using both a generator and the electric grid, in accordance with an example embodiment;

FIG. 2 is a block diagram illustrating a power generation subsystem for use with the system of FIG. 1, in accordance with an example embodiment;

FIG. 3 is a flow chart illustrating an example method for powering an electric load for use with the system of FIG. 1, in accordance with an example embodiment; and

FIGS. 4A-5B are charts illustrating, by way of example, various modes of operation of the system of FIG. 1.

### DETAILED DESCRIPTION

There is provided a system, method, and computer-readable medium for powering an electric load using electric power provided concurrently from a local power generator and the electric grid. A current synchronization subsystem synchronizes the electric current generated by the local generator with a grid current provided by the electric grid to provide a synchronized alternating current to the electric load.

A controller dynamically sets the output power of the local generator in accordance with one of two operating modes.

In the first operating mode, the controller dynamically sets the output power of the local generator to match the power consumed by the electric load, less a baseline level of power. The electric load thus draws the baseline level of power from the electric grid. Any excess power generated by the local generator will reduce the amount of power drawn from the electric grid. The controller thus substantially prevents or substantially reduces the likelihood of backfeed of electric power provided by the local generator into the electric grid. Further, the electric grid remains connected while the local generator is operational, allowing the system to meet peek transient power demands of the electric load using power provided by the electric grid.

In a second operating mode, the controller sets the output power of the local generator to a fixed, baseline level of power. The electric load thus draws the remainder of its electric power demand from the electric grid. Maintaining a baseline output power by the local generator allows the controller to more quickly switch to the first mode. Since the local generator is outputting electric power at almost all times, the electric power provided by the local generator is maintained in a synchronized state with the electric current provided by the electric grid. Further, the generator does not need to be started when the controller switches to the first mode, which may be time consuming.

The controller may switch between the first and second operating modes in response to an external parameter, such as the real-time cost of generating electric power using the local power generator and the real-time cost of drawing electric power from the electric grid. Since the real-time costs may change dynamically, the controller may dynamically switch between the two modes. Accordingly, the controller allows the system to provide the electric load with cheaper electric power.

Accordingly, the controller allows for the local generator to provide electric power to the electric load concurrently with the electric grid. The local generator may thus be used to satisfy electricity generation legislation requiring each residence/commercial building to generate at least a portion of the electric power consumed by the residence/commercial building.

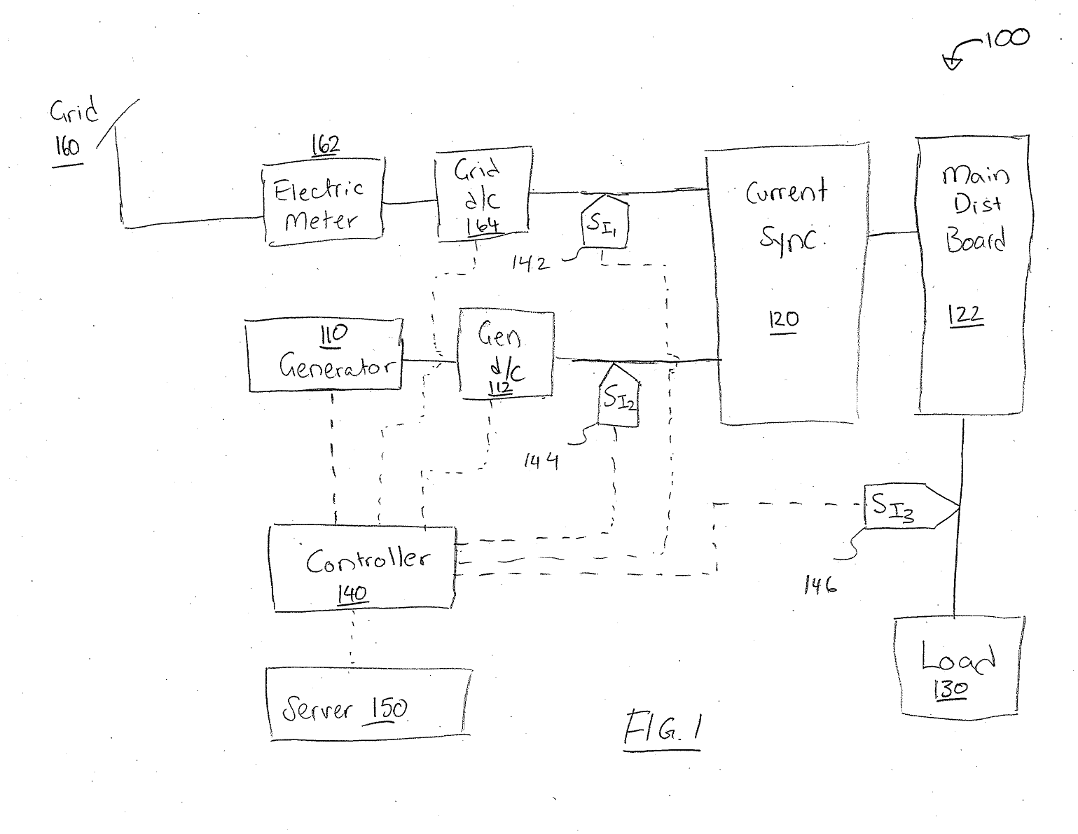

Reference is made to FIG. 1, illustrating a schematic of system 100 for powering electric load 130 from electric power provided by both generator 110 and the electric grid 160 concurrently. Electric load 130 is electrically coupled to both generator 110 and the electric grid 160 for drawing electric power (i.e. electric current) therefrom.

Electric grid 160 provides an alternating electrical current generated by an electric utility to electrical load 130. Electric utility may generate electric power at one or more power generation plants (not shown) and transmit the electric power over power transmission lines (not shown) to a substation (not shown) for distribution to a customer (which may be a residence or commercial building) for powering electric load 130 at the customer.

Electric grid 160 is typically coupled to electric load 130 via an electric meter 162. As is known in the art, electric meter 162 measures the electric power drawn by electric load 130 from electric grid 160, thereby allowing an electric utility to charge the customer for using the electric power provided by electric grid 160.

Electric utilities typically charge the customer for each kilowatt of electric power drawn by electric load 130 from electric grid 160. In some embodiments, the cost of each kilowatt may vary in dependence on the time-of-day (e.g. the cost may be higher during a period of peak demand or during a pre-defined period of anticipated peak demand). The cost of each kilowatt may also vary in dependence on the day of the week and the month of the year, and the cost of each kilowatt may increase or decrease from time to time. In one embodiment, the cost of each kilowatt is set regularly by the electric utility.

A circuit breaker 164 is typically provided for automatically disconnecting electric grid 160 from other components of system 100. As will be appreciated, circuit breaker 164 protects components of system 100 from damage caused by excess current (e.g. due to a short circuit). Circuit breaker 164 may be referred to as an ‘anti-islanding system’. Circuit breaker 164 may also be manually operated to cut off power provided by electric grid 160 to other components of system 100.

In one embodiment, controller 140 may control circuit breaker 164. In response to detecting a power outage (i.e. that electric grid 160 is not providing electric power), controller 140 may disconnect electric grid 160 from system 100 using circuit breaker 164. This may prevent electric current generated by electric generator 110 from backflowing into electric grid 160; as electric current from generator 110 may injure workers responding to the power outage.

Generator 110 generates an alternating or a direct electric current by burning a fuel. Generator 110 may include an internal or external combustion engine rotating a variable speed generator having a configurable output power for a set voltage. Other variable speed constant frequency (‘VSCF’) power generation systems may be used, including single- and doubly-fed electric machines, and magnetohydrodynamic generators.

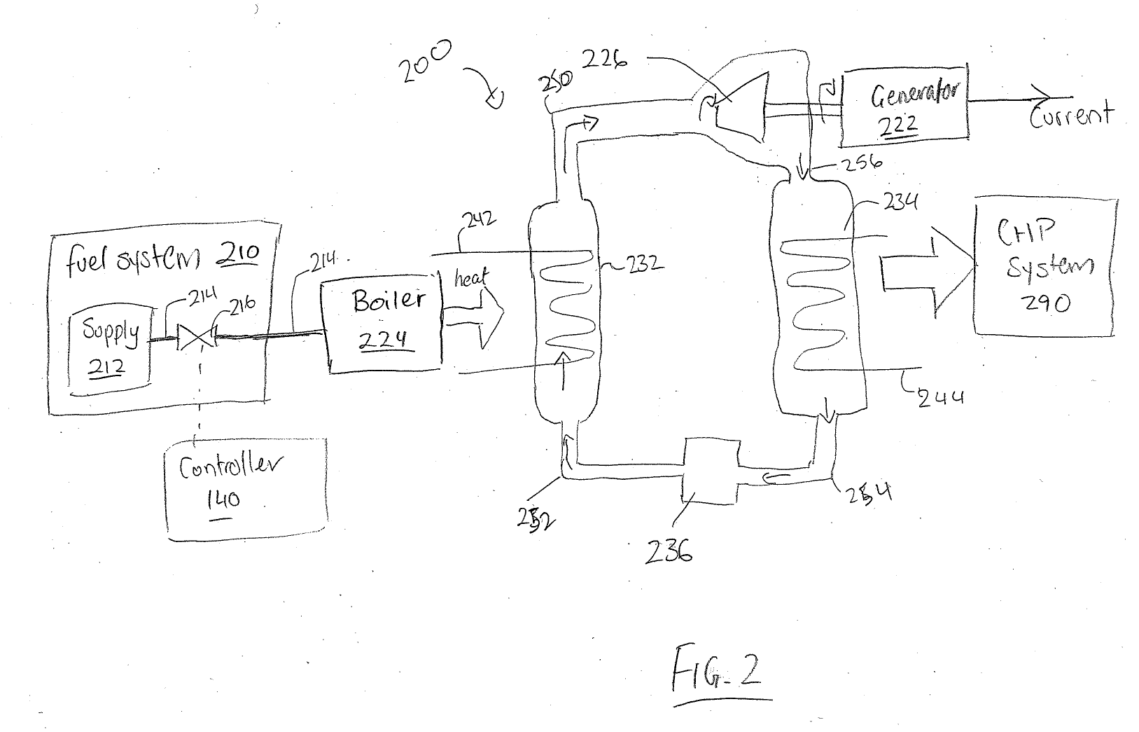

In one embodiment, as illustrated in FIG. 2, generator 110 includes a boiler 224 receiving fuel from a fuel system 210. Fuel system 210 includes a fuel supply 212 for providing boiler 224, via pipe 214; with a fluid based fuel (such as natural gas, propane, diesel, and petrol). Fuel supply 212 may receive fuel from a local utility (e.g. a natural gas company), or alternatively, may include a fuel tank (not shown) storing the fuel locally. Fuel system 210 may also include a valve 216 for controlling an amount of fuel supplied to boiler 224 from either the local utility or the fuel tank. Valve 216 may be coupled to controller 140 for setting an output current of generator 110.

In one embodiment, as illustrated in FIG. 2, heat generated by boiler 224 may be used to heat up an organic, high molecular mass fluid in an organic Rankine Cycle (‘ORC’) 200. Alternatively, a Rakine cycle, using water, may be used.

Heat generated by boiler 224 may heat up fluid in pipes 242. Pipes 242 transfer heat to evaporator 232 of ORC 200, causing the organic fluid of ORC 200 to vaporize and expand. The vapor then flows through pipes 250 of ORC 200 to turbine 226 (e.g. a Tesla turbine), thereby spinning turbine 226 which, in turn, spins generator 222 to produce a current. The vapor then flows down through pipes 256 and through condenser 234. Pipes 242, carrying a cool fluid, interface with condenser 234, causing the vapor to cool, condense, and flow down further through pipe 254 of ORC 200. Pump 236 may then pump fluid in ORC 200 back to evaporator 232 for the cycle to continue. Hot and cold pipes 242, 244 may also be used to provide cooling and heating in a combined heat and power system 290.

Referring back to FIG. 1, in one embodiment, generator 110 is configured to output a direct electric current (‘DC’) at a defined voltage. A DC-AC convertor (not shown), such as an inverter, may be used to convert the direct electric current output of generator 110 to provide AC current to electric load 130. In one embodiment, current synchronization subsystem may include a grid-tie inverter, which receives a direct electric current from generator 110 and outputs an alternating electric current that is synchronized with the alternating electric current provided by electric grid 160 for powering electric load 130.

In one embodiment, generator 110 is configured to output an alternating electric current (‘AC’) at a defined voltage (for example, single-phase 110 V or 220 V, or three-phase 600 V) and at a defined frequency (for example, 50 Hz or 60 Hz). The pre-defined voltage and frequency may be chosen to mimic the voltage and frequency of electric grid 160. In some embodiments, generator 110 may allow switching between two or more settings for the output voltage and frequency (for example, by controller 140 or by modifying one or more push-buttons or pins on generator 110).

Generator 110 may be placed in relative proximity to electric load 130, in contrast to a central power generation plant operated by an electric utility. For example, generator 110 may be placed installed at the same residence, building, or block as electric load 130 (usually placed outdoors). Further, due to the relative proximity to load 130, power generated by generator 110 is not transmitted over electric power transmission lines, thereby minimizing loss of electric power.

Generator 110 may be owned and operated by one or more entities other than the electric utility providing electric grid 160. Accordingly, power generated by generator 110 is not metered by electric meter 162, and generator 110 may be referred to a ‘behind-the-meter’ generator.

In one embodiment, however, generator 110 may be used to contribute power to electric grid 160. Electric power generated by generator 110 may flow from generator 110, via electric meter 162, to electric grid 160. Since electric power is flowing to the electric grid 160 (i.e. not from the electric grid), electric utility may reduce the customer's charge for electricity by a proportional amount.

A circuit breaker 112 is typically provided for automatically disconnecting generator 110 from other components of system 100. As will be appreciated, circuit breaker 112 protects components of system 100 from damage caused by excess current (e.g. due to a short circuit). Circuit breaker 112 may also be manually operated to cut off power provided by generator 110 to other components of system 100.

In one embodiment, controller 140 may control circuit breaker 112. In response to detecting a power outage (i.e. that electric grid 160 is not providing electric power), controller 140 may disconnect generator 110 from system 100 using circuit breaker 112. This may prevent electric current generated by generator 110 from flowing into electric grid 160; as electric current from electric generator 110 may injure workers responding to the power outage. Alternatively, in the event of a power outage, controller 140 may maintain circuit breaker 112 is a closed position, and open circuit breaker 164, thereby allowing generator 110 to power electric load 130.

In some embodiments, controller 140 may disconnect generator 110 from system 100 in response to determining that generator 110 is outputting electric power at a frequency, voltage, or phase that is incompatible with that of electric grid 160.

Generator 110 and electric grid 160 are coupled to current synchronization subsystem 120. Current synchronization subsystem 120 receives a direct or alternating current from generator 110 and an alternating current from grid 160 to provide a synchronized alternating current combining current from both generator 110 and electric grid 160 to electric load 130. Current synchronization subsystem 120 may include one or more internal circuit breaker (not shown) to prevent unsynchronized current from flowing to electric load 130 and to the electric grid 160.

In one embodiment, current synchronization subsystem 120 includes a grid-tie inverter and converts a direct current provided by generator 110 to an alternating current that is synchronized with an alternating current provided by electric grid 160. In one embodiment, current synchronization subsystem 120 includes a rectifier for converting an alternating electric current from generator 110 to a direct electric current, and the direct electric current is provided to the grid-tie inverter. Advantageously, in some embodiments, a grid-tie inverter may provide synchronized alternating electric current relatively quickly.

In one embodiment, current synchronization subsystem 120 includes an automatic synchronizing relay to synchronize the phase of a generator 110 outputting an alternating electric current. The synchronizing relay may determine the phase of an output of generator 110. To ensure that the current generated by generator 110 is synchronized with current drawn from the electric grid 160, synchronizing relay only connects generator 110 to system 100, by closing an internal circuit breaker (not shown), if the phase of the output of generator 110 is synchronized with the phase of the electric current provided by electric grid 160. Synchronizing relay may also control a turbine of generator 110 to bring the output of generator 110 into phase with electric grid 160. Synchronizing relay may also disconnect generator 110 by opening the internal circuit breaker if the output of generator 110 is out of phase by more than a pre-defined amount.

Current synchronization subsystem 120 is electrically coupled to electric load 130 to provide electric load 130 with a synchronized alternating electric current for powering electric load 130 using current from both generator 110 and electric grid 160. Electric load 130 includes electric circuits that consume alternating electric current. Electric load 130 may include electrically powered appliances, electronics, computers and the like.

In one embodiment, circuits of electric load 130 are electrically coupled to main distribution board 122. Main distribution board 122 divides electric power provided by both local generator 110 and the electric grid 160 to subsidiary circuits (for example, to provide electric power to electric outlets in a home or commercial building).

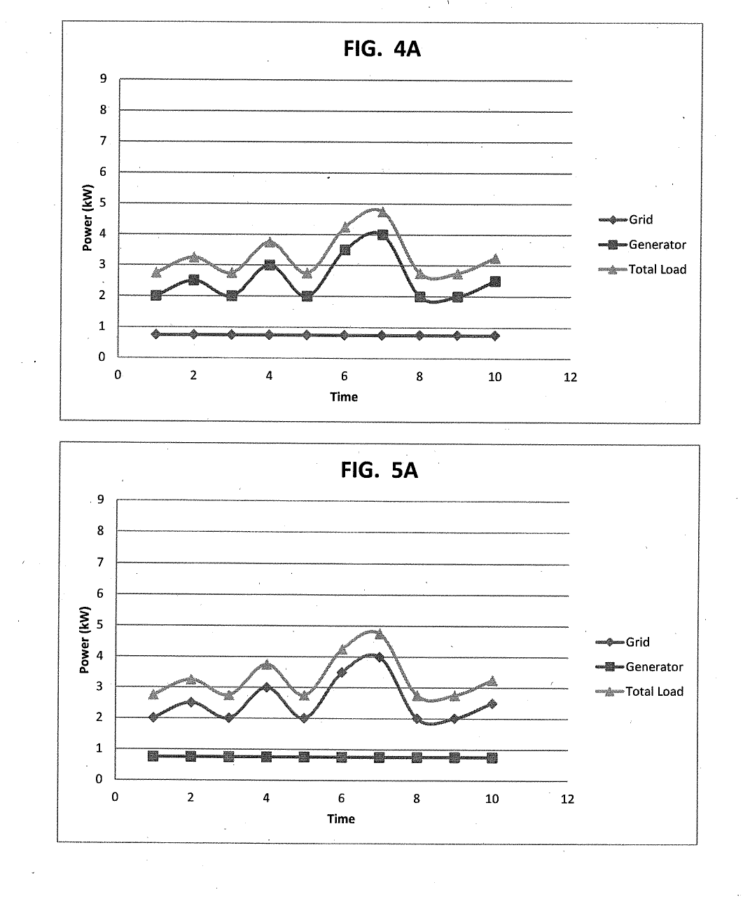

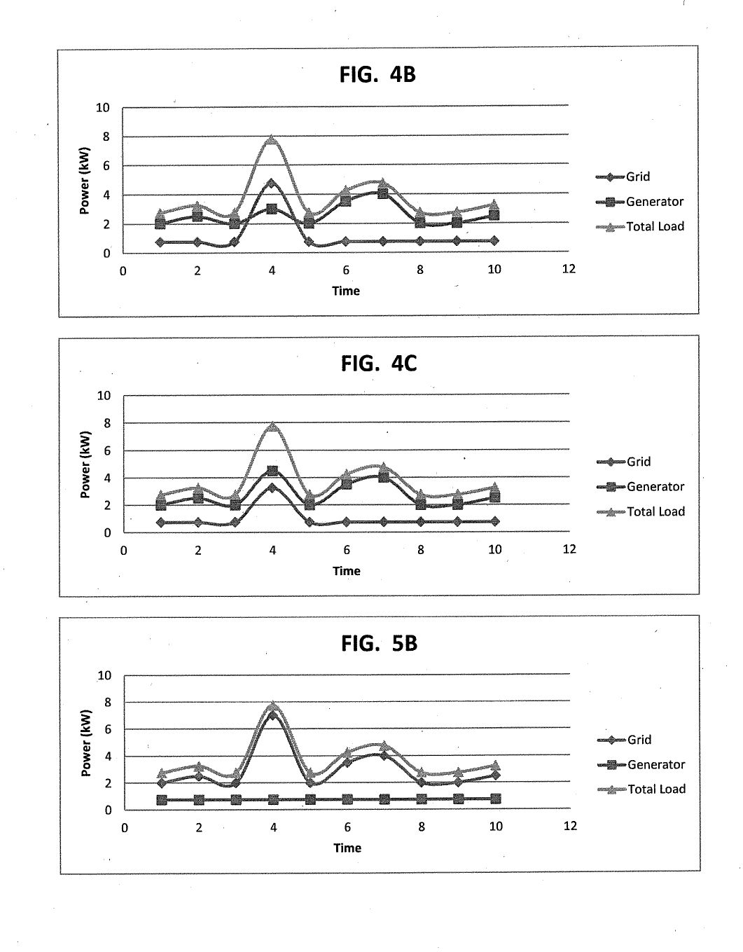

At each particular moment in time, electric load 130 draws a magnitude of electric power/current referred to as an instantaneous power/current. Electric load 130 may draw an instantaneous power that varies over time. Accordingly, the power drawn from one or both of the generator 110 and the electric grid 160 may vary over time, as illustrated by way of example in FIGS. 4A-5B.

Further, electric load 130, from time to time, may suddenly require a significantly higher instantaneous power than a previous time period, as illustrated by way of example at T=4 in FIGS. 4B, 4C, and 5B. The increased level of demand may persist only momentarily (e.g. for milliseconds or microseconds), but may also persist for a longer period of time.

For example, for an electric load 130 that includes an air conditioning system, when a compressor of the air conditioning system is switched on, the instantaneous power drawn by the air conditioning system will increase for a long period of time: Further, switching on the compressor may cause a transient spike in the instantaneous power drawn by the air conditioning system, causing electric load's instantaneous power demand to increase and decrease dramatically over a very short period of time.

To ensure that the electric power demands of electric load 130 are met, controller 140 may cause generator 110 to increase its output power in response to an increase in the instantaneous power drawn by electric load 130. Alternatively, controller 140 may maintain the output power of generator 110 constant, thereby causing electric load 130 to draw additional electric power from electric grid 160, which has capacity to provide the excess power demanded.

Controller 140 controls the overall operation of system 100, including, the output power of generator 110. Controller 140 may also control circuit breakers 164, 112 to automatically disconnect either of the electric grid 160 and generator 110 from system 100. Controller 140 may include a microprocessor, memory, and an input/output interface for providing output to a user, receiving user input, and receiving information relating to one or more external parameters from one or more servers 150.

Controller 140 may receive one or more external parameters from server 150, such as a real-time cost of generating electric power using generator 110 and a real-time cost of electric power provided by the electric grid 160. Server 150 may receive real-time cost information from the electric utility company providing electric grid 160. Server 150 may also receive real-time cost information from the utility company providing fuel for generator 110. Controller 140 may act in response to the external parameters provided by server 150, for example, by increasing or decreasing an output power of generator 110, or by switching from the first operating mode to the second operating mode or vice-versa.

Controller 140 may be coupled to one or more current sensors 142, 144, 146 for measuring current at different points in system 100. For example, current sensor 142 is coupled to an input from electric grid 160 for sensing current drawn from electric grid 160, current sensor 144 is coupled to an output of generator 110 for sensing an output current generated by generator 110, and current sensor 146 is coupled to electric load 130 for sensing a current drawn by electric load 130. Current sensors 142, 144, 146 may sense instantaneous current, or an average current over a defined period of time, and provide the sensor input to controller 140.

Controller 140 may receive sensor inputs and may act in response to the sensor inputs, for example, by increasing an output power of generator 110 when the instantaneous current drawn from the electric grid 160 is increasing over time. Similarly, controller 140 may decrease an output power of generator 110 when the instantaneous current drawn from the electric grid 160 is decreasing over time. Further, controller 140 may increase or decrease the output power of generator 110 if, based on a sensor input from sensor 144, the output power of generator 110 is falling short or is in excess of the desired output power, respectively. Further, controller 140 may decrease or increase the output power of generator 110 if, based on a sensor input from sensor 142, electric load 130 is drawing less than or in excess of the desired power to be drawn from the electric grid 160, respectively.

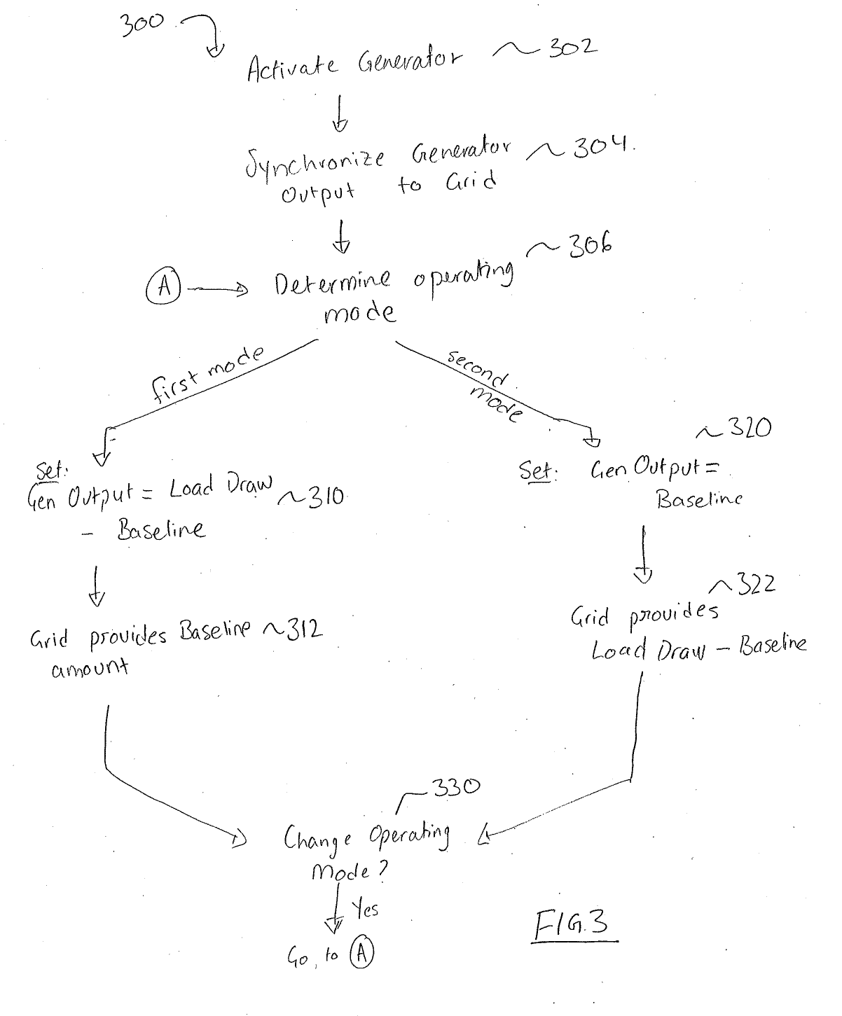

Reference is now made to FIG. 3 showing a flowchart depicting blocks an example method 300 for controlling system 100 to power electric load 130 with electric current provided by both generator 110 and the electric grid 160 concurrently. Computer-readable instructions implementing method 300 may be stored in a memory of controller 140 for execution by a processor of controller 140.

At 302, generator 110 is activated. To activate generator 110, controller 140 may control a starter circuit of generator 110 to initiate an engine or boiler 224 of generator 110. Alternatively, generator 110 may be manually started.

Circuit breaker 112 is initially open, as the initial current output of generator 110 may be out-of-sync with current from electric grid. Further, generator 110 may need several cycles to ramp up and to stabilize its output.

Once the electric current output of generator 110 is stable, controller 140 may set generator 110 to provide an initial level of electric power. Alternatively, the initial output power of generator 110 may be manually set. Circuit breaker 112 may then be closed to allow current to flow to current synchronization system 120.

The electric current output from generator 110 may be synchronized, at 304, with current drawn from the electric grid 160. For a generator 110 that provides a DC output, current synchronization system 120 will convert, synchronize, and combine the DC output with current drawn from the electric grid 160 to output a synchronized alternating current. For a generator 110 that provides an AC output, current synchronization system 120 will synchronize and combine the AC output with current drawn from the electric grid 160 to output a synchronized alternating current.

At 306, controller 140 determines an operating mode for system 100 based on an external parameter. In a first operating mode, a minimal baseline level of electric power is provided by electric grid 160, and the remainder is provided by generator 110. Notably, in the first operating mode, controller 140 varies the output power of local generator 110 in response to a change in an instantaneous power drawn by electric load 130. The first operating mode may be preferred if the real-time cost of generating electric power by generator 110 is lower than the real-time cost of drawing electric power from electric grid 160.

In a second operating mode, a minimal baseline level of electric power is provided by electric generator 110, and the remainder is provided by electric grid 160. The second operating mode may be preferred if the real-time cost of generating electric power by generator 110 is greater than or equal to the real-time cost of drawing electric power from electric grid 160.

In one embodiment, real-time cost information may be provided by server 150. Controller 140 may send a request to server 150 to receive real-time cost information. Server 150 may respond to the request by providing the real-time cost information. Alternatively, server 150 may provide an interface for accessing real-time cost information, which controller 140 may access.

In one embodiment, real-time cost information provided by server 150 may include a cost-per-kilowatt for drawing electric power from the electric grid 160, and a time period for which the cost-per-kilowatt is valid (e.g. the next 30 minutes, until 6 PM, and so forth). Real-time cost information provided by server 150 may also include a cost-per-unit of fuel used by generator 110 and a time period for which the cost-per-unit is valid.

Alternatively, cost information may be stored in a database in memory of controller 140. Cost information may be updated regularly (e.g. weekly, monthly, yearly, or when a change to costs occur) to ensure accuracy. Cost information stored in memory may, nonetheless, provide real-time cost information as the cost information may be static for long periods of time. Further, cost information stored in memory may be related to particular periods of time (e.g. costs that vary based on time-of-day).

Controller 140 may determine a cost-per-kilowatt of generated electric power using a cost function, which takes into account one or more variables for computing the cost-per-kilowatt. The cost function and the variables may be stored in a database in memory of controller 140. Variables of the cost function may include: the make and model of generator 110, the number of units of fuel needed to generate each kilowatt using generator 110, the cost of owning and maintaining generator 110, the cost of ancillary fluids needed (e.g. engine oil), and the marginal cost to generate the next kW (i.e. the cost-per-kilowatt may be non-linear).

If, at 306, controller 140 selects the first operating mode (i.e. the cost of generating electric power using generator 110 is lower than the cost of drawing electric power from electric grid 160), method 300 moves to block 310.

At 310, controller 140 sets an output of generator 110 to provide electric load 130 with electric power equal to an instantaneous power drawn by electric load 130 less a defined baseline power. Controller 140 may determine the instantaneous power drawn by electric load 130 using a sensor input provided by current sensor 146 at electric load 130. As previously discussed, the instantaneous power drawn by electric load 130 may vary over time, and as such, the controller 140 may dynamically set the output of generator 110 over time. In other words, controller 140 will monitor the instantaneous current drawn by electric load 130 and increase or decrease the output power of generator 110 according to changes in the instantaneous power drawn by electric load 130.

Further, at 312, because electric load 130 is drawing more electric power than the electric power provided by generator 110, electric load 130 draws a baseline power from electric grid 160. The power drawn from electric grid 160 is substantially constant over time.

The level of electric power provided by each of electric grid 160 and generator 110 in the first operating mode is demonstrated, by way of example, in the graph of FIG. 4A. As illustrated, electric grid 160 provides a steady level of baseline electric power (0.75 kW), and the power provided by generator 110 varies over time to provide electric load 130 with a total power equal to the total load demanded by electric load 130.

While, in the first operating mode, the cost of generating electric power using generator 110 is lower than the cost of drawing electric power from electric grid 160, generator 110 does not provide electric load 130 with all of the instantaneous power drawn by electric load 130. Indeed, electric grid 160 provides electric load 130 with a baseline level of electric power.

Drawing a near constant, baseline level of electric power from the electric grid 160 may be advantageous. For example, while controller 140 may increase or decrease the output of generator 110 according to changes in the instantaneous power drawn by electric load 130, controller 140 and generator 110 may not respond to changes to the instantaneous power drawn quickly enough. Accordingly, the electric grid 160 may provide the excess power demanded by electric load 130, thereby preventing a short-circuit.

In one example, electric grid 160 provides electric power in addition to the baseline level if the output of generator 110 falls short. This is particularly helpful in responding to transient spikes in demand by electric load 130, as controller 140 and generator 110 may not be able to output a sufficient increase in power quickly enough to meet the sudden increase in demand. Further, the marginal cost of generating an output power sufficient to meet the sudden increase in demand may be higher than the marginal cost of slowly increasing the output power.

As illustrated by way of example in FIG. 4B, in response to a transient spike in demand at T=4, controller 140 does not increase the output of generator 110. Instead, electric load 130 draws the excess demand from the electric grid 160 (at T=4, generator 110 provides 3 kW, and grid 160 provides 4.75 kW). Controller 140 may alternatively increase the output of generator 110 only partially in response to a transient spike in demand, as illustrated, by way of example in FIG. 4C at T=4 (generator 110 provides 4.5 kW, and grid 160 provides 3.25 kW).

Furthermore, a transient spike in demand by electric load 130 may cause the instantaneous power drawn by electric load 130 to exceed a maximum output capacity of generator 110. Accordingly, controller 140 may set the output power of local generator 110 to the lessor of the maximum output capacity of generator 110 and the instantaneous power drawn by electric load 130 less the baseline power.

In another example, the output of generator 110 may exceed the defined output power set by controller 140. Since the defined output power depends on the instantaneous power drawn by electric load 130, if the instantaneous power drawn drops quickly, generator 110 may generate excess output. Electric load 130 may nonetheless dissipate the excess power generated by generator 110; thereby causing the baseline power drawn from the electric grid 160 to decrease. Had generator 110 provided all of the instantaneous power drawn by electric load 130, any excess electric power generated by generator 110 will not be dissipated by electric load 130. Instead, the excess electric power will either be wasted or backfed to the electric grid 160. Accordingly, by setting generator 110 to generate less electric power than needed, controller 140 may help substantially prevent electric power from being wasted and/or being backfed into the electric grid 160 through current synchronization subsystem 120.

Controller 140 may increase or decrease the baseline power to be provided by electric grid 160 based on fluctuations in the power drawn by electric load 130 over a period of time. In one embodiment, if the power drawn by electric load 130 fluctuates significantly over time, then controller 140 may increase the baseline power provided by electric grid 160 to reduce the likelihood of backflow of electric power provided by generator 110 to electric grid 160. In one embodiment, if the power drawn by electric load 130 is relatively stable over time, then controller 140 may decrease the baseline power provided by electric grid 160 as the likelihood of backflow of electric power provided by generator 110 to electric grid 160 is lower.

Furthermore, by constantly drawing electric power from the electric grid 160, the power generated by generator 110 can be maintained in a synchronized state with the electric power from the electric grid 160. This allows for quicker switching between the first and second operating modes.

Referring back to FIG. 3, if, at 306, controller 140 selects the second operating mode (i.e. the cost of generating electric power using generator 110 is greater than or equal to the cost of drawing electric power from electric grid 160), method 300 moves to block 320.

At 320, controller 140 sets generator 110 to provide electric load 130 with a fixed power output. The power generated by generator 110 is substantially constant over time.

At 322, because electric load 130 is drawing more electric power than the electric power provided by generator 110, electric load 130 draws the remainder of the instantaneous power from by the electric grid 160.

The level of electric power provided by each of electric grid 160 and generator 110 in the second operating mode is demonstrated, by way of example, in the graph of FIG. 5A. As illustrated, generator 110 provides a steady level of baseline electric power (0.75 kW), and the power provided by electric grid 160 varies over time to provide electric load 130 with a total power equal to the total power demanded by electric load 130. Further, as illustrated, by way of example, in FIG. 5B at T=4, in response to a transient spike in demand, controller 140 will not change the output of generator 110; thereby causing electric load 130 to draw the excess demand from the grid (generator 110 provides the baseline level of power of 0.75 kW, whilst the electric grid 160 provides 7 kW).

After selecting the operating mode, controller 140 may determine, at 330, if the operating mode should be changed (i.e. switched from the first operating mode to the second operating mode, or switched from the second operating mode to the first operating mode). Controller 140 may thus continue to monitor the real-time cost of generating electric power by generator 110 and the real-time cost of drawing electric power from electric grid 160. In one embodiment, controller 140 monitors the real-time cost information periodically. The time period between each period may range from seconds to days, depending on how often the real-time cost information is expected to change. In one embodiment, server 150 notifies controller 140 of a change in cost information. If the cost-information is modified, method 300 moves to block 306 and determines an operating mode based on the new real-time cost information.

Accordingly, system 100 may provide electric load 130 with electric power from both electric grid 160 and generator 110 concurrently.

### CONCLUDING REMARKS

Other features, modifications, and applications of the embodiments described here may be understood by those skilled in the art in view of the disclosure herein.

It will be understood that any range of values herein is intended to specifically include any intermediate value or sub-range within the given range, and all such intermediate values and sub-ranges are individually and specifically disclosed.

The word “include” or its variations such as “includes” or “including” will be understood to imply the inclusion of a stated integer or groups of integers but not the exclusion of any other integer or group of integers.

It will also be understood that the word “a” or “an” is intended to mean “one or more” or “at least one”, and any singular form is intended to include plurals herein.

It will be further understood that the term “comprise”, including any variation thereof, is intended to be open-ended and means “include, but not limited to,” unless otherwise specifically indicated to the contrary.

When a list of items is given herein with an “or” before the last item, any one of the listed items or any suitable combination of two or more of the listed items may be selected and used.

Of course, the above described embodiments of the present disclosure are intended to be illustrative only and in no way limiting. The described embodiments are susceptible to many modifications of form, arrangement of parts, details and order of operation. The invention, rather, is intended to encompass all such modification within its scope, as defined by the claims.

What is claimed is:

1. A system for powering an electric load, the system comprising:
a local generator generating an electric current;
a current synchronization subsystem coupled to said local generator and to an electric grid, synchronizing the electric current generated by said local generator with a grid current provided by the electric grid to provide a synchronized alternating current to said electric load; and
a controller coupled to said local generator and said electric load, said controller operable to dynamically set an output power of said local generator to provide said electric load with electric power equal to an instantaneous power drawn by said electric load less a defined baseline power, and cause said electric grid to provide said defined baseline power to said electric load.

2. The system of claim 1, wherein said controller varies the output power of said local generator in response to a change in said instantaneous power drawn by said electric load.

3. The system of claim 1, wherein said controller is further operable to select a second operating mode based on an external parameter, wherein in the second operating mode said controller is operable to set said output power of said local generator to a fixed power output, and cause a remainder of said instantaneous power drawn by said electric load to be provided by the electric grid.

4. The system of claim 3, wherein said controller is further operable to
determine a real-time cost of generating electric power and a real-time cost of electric grid power, and
in response to determining that the real-time cost of generating electric power is greater than or equal to the real-time cost of said electric grid power, selecting said second operating mode.

5. The system of claim 4, wherein said controller receives said real-time cost of generating electric power and said real-time cost of said electric grid power from a server over a network.

6. The system of claim 1, wherein said controller is operable to set said output power of said local generator to the lessor of (i) a maximum output capacity of said local generator and (ii) the instantaneous power drawn by said electric load less said defined baseline power.

7. The system of claim 1, wherein said controller substantially prevents said electric current generated by said local generator from being backfed into the electric grid.

8. The system of claim 1, wherein the local generator is a variable speed generator having a configurable output current.

9. The system of claim 8, wherein said variable speed generator is implemented using an organic Rankine Cycle.

10. The system of claim 1, wherein said local generator comprises a fuel system having a valve for controlling an amount of fuel supplied to said local generator, said valve being coupled to said controller for setting said output power of said local generator.

11. The system of claim 1, wherein said current synchronization subsystem includes a grid-tie inverter.

12. The system of claim 1, further comprising instantaneous current sensors for sensing an instantaneous current drawn by said electric load, an instantaneous current generated by said local generator, and an instantaneous current drawn from the electric grid; and wherein said instantaneous current sensors provide sensor inputs to said controller.

13. The system of claim 12, wherein said controller is further operable to receive sensor inputs from said instantaneous current sensor sensing said instantaneous current drawn from the electric grid, and wherein when said instantaneous current drawn from the electric grid is increasing over time, setting said local generator to increase said output power of said local generator.

14. A method for powering an electric load, the method comprising:
generating, by a local generator, an electric current;
dynamically setting, by a controller, an output power of said local generator to provide said electric load with electric power equal to an instantaneous power drawn by said electric load less a defined baseline power;
causing, by said controller, an electric grid to provide said defined baseline power to said electric load; and
synchronizing, by a current synchronization subsystem, the electric current generated by said local generator with a grid current drawn from said electric grid.

15. The method of claim 14, further comprising:
selecting a second operating mode based on an external parameter;
in response to selecting said second operating mode, setting said output power of said local generator to a fixed output, and
causing a remainder of said instantaneous power drawn by said electric load to be provided by the electric grid.

16. The method of claim 15, further comprising determining a real-time cost of generating electric power and a real-time cost of said electric grid power; and in response to determining that the real-time cost of generating said electric power is greater than or equal to the real-time cost of said electric grid power, selecting said second operating mode.

17. The method of claim 16, further comprising receiving said real-time cost of generating electric power and said real-time cost of said electric grid power from a server over a network.

18. The method of claim 14, further comprising setting said output power of said local generator to the lessor of (i) a maximum output capacity of said local generator and (ii) the instantaneous power drawn by said electric load less said defined baseline power.

19. The method of claim 14, wherein the local generator is a variable speed generator having an output power configurable by said controller.

20. The method of claim 14, wherein said local generator comprises a fuel system having a valve for controlling an amount of fuel supplied to said local generator, and wherein setting, by said controller, said output power of said local generator comprises setting a position of said valve.

21. The method of claim 14, further comprising
receiving sensor inputs from an instantaneous current sensor indicative of an instantaneous current drawn by said electric load; and
when said instantaneous current drawn from the electric grid is increasing over time, setting said local generator to increase said output power of said local generator.

22. A non-transitory computer readable storage medium including instructions that when executed by a system for providing electric power to an electric load, the system comprising a local generator generating an electric current, a current synchronization subsystem coupled to said local generator and to an electric grid, synchronizing said electric current generated by said local generator with a grid current provided by the electric grid, and a controller coupled to at least one of said local generator, said electric load, to cause the system to: dynamically set an output power of said local generator to provide said electric load with electric power equal to an instantaneous power drawn by said electric load less a defined baseline power, and cause the electric grid to provide said defined baseline power to said electric load.

23. The non-transitory computer readable storage medium of claim 22, wherein the instructions cause the system to: select a second operating mode based on an external parameter, wherein in the second operating mode said controller is configured to set said output power of said local generator to a fixed output, and cause a remainder of said instantaneous power drawn by said electric toad to be provided by the electric grid.
